(19) United States
(12) Patent Application Publication
(10) Pub. No.: US 2014/0014579 A1
(43) Pub. Date: Jan. 16, 2014

(54) SYSTEMS, METHODS AND APPARATUSES FOR CENTRALIZED FILTRATION OF WATER

(71) Applicant: Telecomsultants, Inc., Irving, TX (US)

(72) Inventor: AbdulRazaq Haruna, Round Rock, TX (US)

(21) Appl. No.: 13/938,732

(22) Filed: Jul. 10, 2013

Related U.S. Application Data
(60) Provisional application No. 61/669,936, filed on Jul. 10, 2012.

(51) Int. Cl. C02F 9/00

(52) U.S. Cl. CPC C02F 9/00
USPC 210/636; 210/258

(57) ABSTRACT

A water filtration device comprising a water pump for providing water, a first carbon filter that receives water from the water pump, a first ball valve having a first opening connected to the first carbon filter, a first ultrafiltration membrane that receives water from the first carbon filter after it passes through the first opening, a second ball valve having a second opening and connected downstream from the first ultrafiltration membrane, a second ultrafiltration membrane that receives water from the first carbon filter through the second opening, said second ultrafiltration membrane being positioned downstream said first carbon filter, wherein water can flow simultaneously through the first ultrafiltration membrane and the second ultrafiltration membrane from the first carbon filter, a second carbon filter connected downstream from the first and second ultrafiltration membranes that receives and filters water from the first and second ultrafiltration membranes, resulting in producing purified water.

### FIELD OF THE INVENTION

The general inventive concepts relate to water filtration and, more particularly, to systems, methods, and apparatuses for a centralized water filtration system.

### BACKGROUND

Historically, water filtration systems have been developed to filter commonly occurring water contaminants in small quantities. These traditional water filtration systems have focused primarily on treating municipal water, which is typically pre-treated (e.g. with chlorine) prior to being transported to dwellings. However, despite being pre-treated, municipal water is usually further contaminated during the transportation process to the dwellings.

In many parts of the world, users of water may not have access to municipal water, and may have to rely on “raw” water to fulfill their water needs. Raw water is any type of non-municipal water, comprising stream water, river water, ocean water, surface water and underground water, among others. Raw water is highly contaminated, as compared to municipal water, and traditional water filtration systems fail to remove acceptable amounts of contaminants from such raw water.

Furthermore, in many parts of the world, water flow from the municipalities and/or water supply lines is not at a consistent pressure. And, the existing water filtration systems are not equipped to supply a constant flow of water at a consistent pressure.

In view of the above, there is an unmet need for systems, methods and apparatuses for centralized filtration of water, which runs in conjunction with a dwelling's native water storage system, or which allows the user to connect the incoming water source to the centralized filtration of water, and which allows for a constant flow of water at a consistent pressure.

### BRIEF SUMMARY

The general inventive concepts contemplate systems, methods, and apparatuses for centralized filtration of water. By way of example, to illustrate various aspects of the general inventive concepts, several exemplary embodiments of systems, methods and/or apparatuses are disclosed herein.

Systems, methods, and apparatuses, according to one exemplary embodiment, provide for an apparatus for centralized filtration of water. In one embodiment, the apparatus for centralized filtration of water comprises active carbon filters, ultrafiltration membranes, a pressure transmitter, a water pump, electricity ball valves, check valves, pipes for transporting filtered water, a feed water inlet, and a drainage water outlet. Additionally, an electronic control module is provided.

Systems, methods, and apparatuses, according to one exemplary embodiment, provide for an apparatus for centralized filtration of water. In one embodiment, the apparatus for centralized filtration of water comprises a booster pump, a quartz sand filter, an active carbon filter, a polypropylene (“pp”) sediment filter, a multi-phase pump, a reverse osmosis system with reverse osmosis membranes, and a pure water tank. Additionally, an electronic control module is provided.

Additional features and advantages will be set forth in part in the description that follows, and in part will be obvious from the description, or may be learned by practice of the embodiments disclosed herein. The objects and advantages of the embodiments disclosed herein will be realized and attained by means of the elements and combinations particularly pointed out in the specification. It is to be understood that both the foregoing brief summary and the following detailed description are exemplary and explanatory only and are not restrictive of the embodiments disclosed herein or as claimed.

### BRIEF DESCRIPTION OF THE SEVERAL VIEWS OF THE DRAWINGS

The accompanying drawings, which are incorporated in and constitute a part of this specification, illustrate some embodiments disclosed herein, and together with the description, serve to explain principles of the embodiments disclosed herein.

FIG. 1 depicts a first embodiment of an exemplary apparatus for centralized filtration of water.

FIG. 2 depicts a perspective view of the interior of apparatus described in FIG. 1.

FIG. 3 depicts a perspective view of the interior of apparatus described in FIG. 1.

FIG. 4 shows technical parameters for the apparatus described in FIG. 1.

FIG. 5 shows a structural or schematic drawing of the apparatus described in FIG. 1.

FIG. 6 depicts the working of a filtration system of the apparatus described in FIG. 1.

FIG. 7 depicts the working of a flushing system of the apparatus described in FIG. 1.

FIG. 8 depicts a second embodiment of an exemplary apparatus for centralized filtration of water.

FIG. 9 shows technical parameters for the apparatus described in FIG. 8.

FIG. 10 shows a structural or schematic drawing of the apparatus described in FIG. 8.

FIG. 11 shows an electrical schematic drawing of the apparatus described in FIG. 8.

FIG. 11A shows a work flow diagram of the apparatus described in FIG. 8.

FIG. 12 shows an electro-mechanical layout diagram of the apparatus described in FIG. 8.

FIG. 13 depicts an electronic control module used in conjunction with the apparatus described in FIG. 8.

FIG. 14 depicts a structural or schematic drawing of the electronic control module used in conjunction with the apparatus described in FIG. 8.

FIG. 15 depicts an instrument panel in connection with the apparatus described in FIG. 8.

### DETAILED DESCRIPTION

The embodiments disclosed herein will now be described by reference to some more detailed embodiments, with occasional reference to the accompanying drawings. These embodiments may, however, be embodied in different forms and should not be construed as limited to the embodiments set forth herein. Rather, these embodiments are provided so that this disclosure will be thorough and complete, and will fully convey the scope of the embodiments to those skilled in the art.

Unless otherwise defined, all technical and scientific terms used herein have the same meaning as commonly understood by one of ordinary skill in the art to which these embodiments belong. The terminology used in the description herein is for describing particular embodiments only and is not intended to be limiting of the embodiments. As used in the specification and the appended claims, the singular forms “a,” “an,” and “the” are intended to include the plural forms as well, unless the context clearly indicates otherwise.

Unless otherwise indicated, all numbers expressing temperature, flow rates, wattage, voltage, resistance and so forth used in the specification and claims are to be understood as being modified in all instances by the term “about.” Accordingly, unless indicated to the contrary, the numerical parameters set forth in the specification are approximations that may vary depending upon the desired properties sought to be obtained by the present embodiments. At the very least, and not as an attempt to limit the application of the doctrine of equivalents to the scope of the specification, each numerical parameter should be construed in light of the number of significant digits and ordinary rounding approaches.

Notwithstanding that the numerical ranges and parameters setting forth the broad scope of the embodiments are approximations, the numerical values set forth in the specific examples are reported as precisely as possible. Any numerical value, however, inherently contains certain errors necessarily resulting from the standard deviation found in their respective testing measurements. Every numerical range given throughout this specification will include every narrower numerical range that falls within such broader numerical range, as if such narrower numerical ranges were all expressly written herein.

It should be noted that for the purposes of this application, the terms attach (attached), connect (connected), and link (linked) are not limited to direct attachment, connection, or linking but also include indirect attachment, connection, or linking with intermediate parts, components, or assemblies being located between the two parts being attached, connected, or linked to one another. In addition, the terms attach (attached), connect (connected), and link (linked) may include two parts integrally formed or unitarily constructed. As used herein, the term “downstream” denotes the direction of flow of water through the system, while “upstream” denotes a direction through the system that is opposite to the flow.

As described above in the background section, there is an unmet need for systems, methods and apparatuses for centralized filtration of water, which runs in conjunction with a dwelling's native water storage system, or which allows the user to connect the incoming water source to the centralized filtration of water. The present invention resolves the need by way of two embodiments, each of which is designed to treat an incoming supply of water, convert said water to a drinkable state, and deliver the drinkable water continuously and with consistent pressure to any faucet of a dwelling. Now, with particular reference to the drawings, exemplary embodiments of the invention are described below.

### First Embodiment

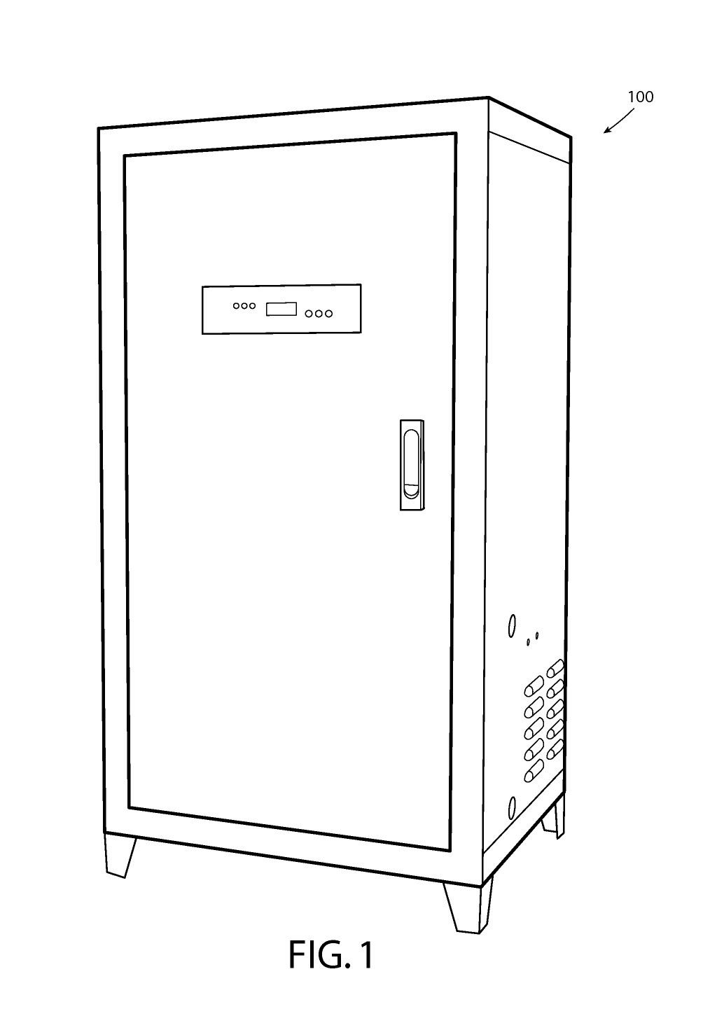

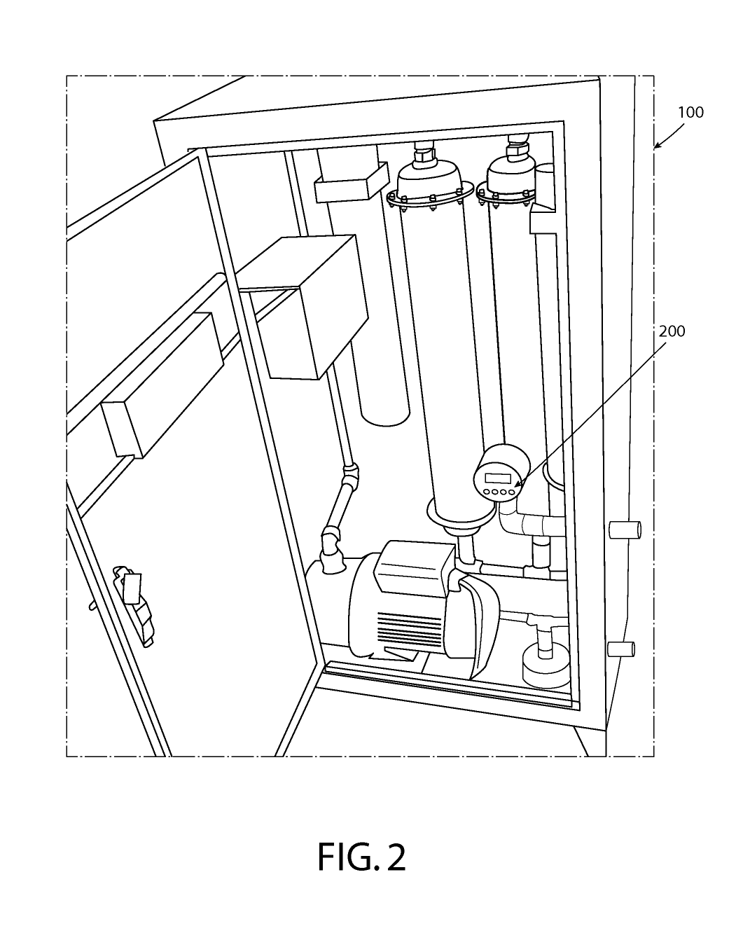

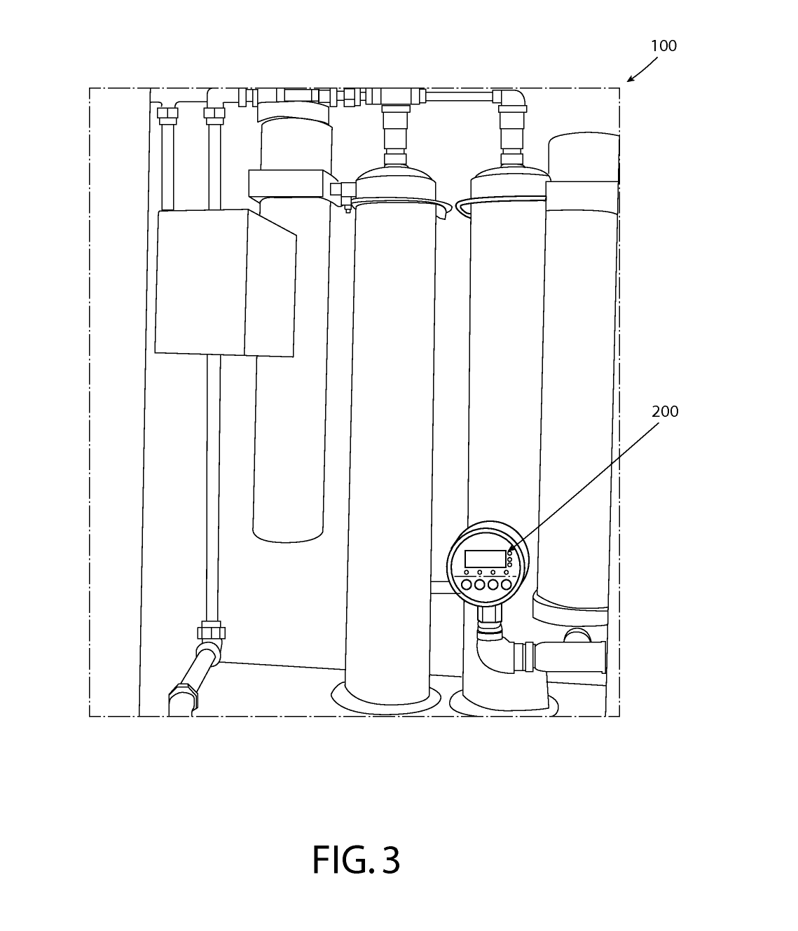

FIG. 1 depicts an exemplary apparatus 100 for centralized filtration of water. FIGS. 2 and 3 depict perspective views of the interior of apparatus 100.

Apparatus 100 has a programmable electronic control module 200, with a microprocessor, through which the user may interact with the apparatus 100 and regulate various features and functioning of apparatus 100, such as a self cleaning operation of the apparatus 100.

In one embodiment, apparatus 100 is configured to operate as a centralized water filtration system for continuously flowing water supply. Apparatus 100 is configured to work even in tropical and sub-tropical climates, including arid and semi-arid conditions. Apparatus 100 functions by utilizing Ultrafiltration (hereinafter referred to as “UF”) membranes that physically remove contaminants, including but not limited to, suspended particles, bacteria, viruses, and other pathogens. Ultrafiltration (UF) is a separation process using membranes with pre-determined pore sizes in the range of 0.1 micron to 0.001 micron. Typically, UF membranes remove high molecular-weight substances, colloidal materials, and organic and inorganic polymeric molecules. Specifically, a 6-log reduction in bacteria and protozoa is achieved. Further, milk proteins, gelatin, end toxin pathogens, viruses, colloidal silica, and all organic and non organic substances with molecular cut-off weight up to 20,000 Daltons are removed as well. Also, typically, low molecular-weight organics and ions such as sodium, calcium, magnesium chloride, and sulfate are not removed by UF membranes. UF membranes can take a wide variety of different forms. Examples include, but are not limited to, spiral wound modules, tubular membranes, and hollow fiber membranes. Additionally apparatus 100 utilizes active carbon filters which filter any chlorine present in the water. Active carbon filters can take a wide variety of different forms. Examples include, but are not limited to, powdered block filters and granular activated filters. Filtering chlorine often leads to an improvement in the taste of the drinking water. Apparatus 100 is designed such that 99.9999% of the viruses, bacteria, and other pathogens in water are removed by the inventive filtration mechanism, described in more detail below. Apparatus 100 is further designed to have enough capacity to supply water continuously, and without storing the water prior to filtering, to the users in a dwelling, making it a centralized and an on-demand system.

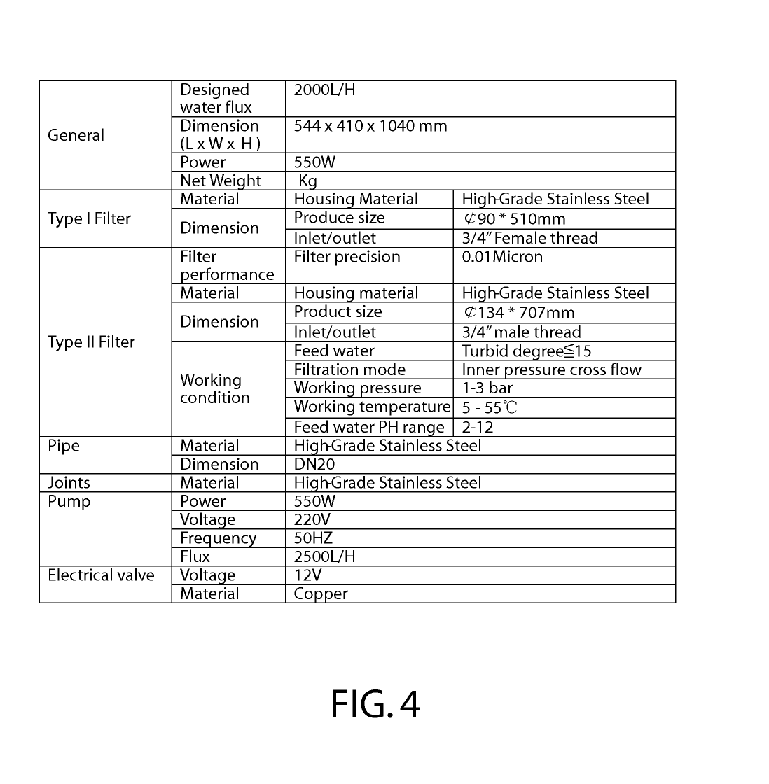

In one embodiment, apparatus 100 has a water flux of 2000 liters per hour, water flow rate of 1000 liters per hour, and supports power supply inputs of 110 Volts, 220 Volts and 347 Volts. Water flow rates in apparatus 100 are adjustable. Moreover, apparatus 100 is also equipped with an outlet water pressure compensation function, which is designed to set the water flow pressure at any different level depending on the needs of the user. The usual pressure is typically between 30 psi and 80 psi. For example, flow rates or water pressures required for high-capacity dwellings, such as apartments, offices, hotels, factories, hospitals, shopping malls, and restaurants are different from the flow rates or water pressures required at residential dwellings. One of ordinary skill in the art will appreciate that any other type of technical parameters may be utilized in the present invention, without deviating from the spirit and scope of the present invention. For example, an alternate power supply input of 277 Volts or any other voltage input may be used in the invention. Other technical parameters for an exemplary embodiment of apparatus 100 are described in further detail in FIG. 4.

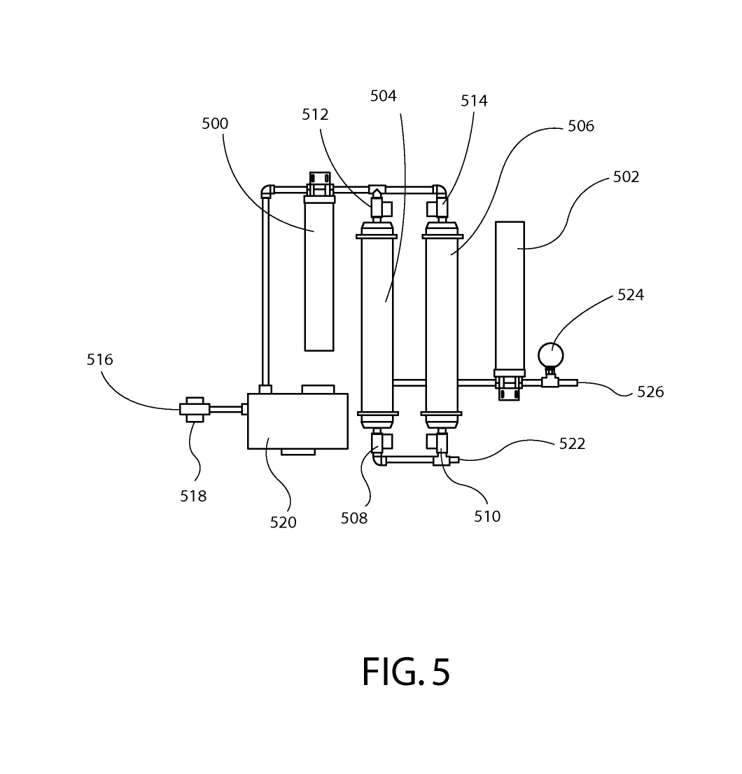

An exploded view of the various components in apparatus 100 is shown in FIG. 5. Although the several components are shown as being attached or linked or connected in a certain embodiment, one or ordinary skill in the art would appreciate that any combination of the several components may be incorporated without deviating from the spirit and scope of the present invention.

The exploded view of apparatus 100 in FIG. 5 provides the components which make up the structural details of apparatus 100. For instance, apparatus 100 comprises of a first active carbon filter (500), a second active carbon filter (502), a first UF membrane (504), a second UF membrane (506), a first electricity ball valve (508), a second electricity ball valve (510), a third electricity ball valve (512), a fourth electricity ball valve (514), a feed water inlet (516), a check valve (518), a pump (520), a drainage water outlet (522), a pressure transmitter (524), and a purified water outlet (526).

Initial Setup of Apparatus 100 and Electronic Control Module 200:

After the installation of apparatus 100 and electronic control module 200, open a purified water tap (not shown) and a feed water valve (not shown). When water flows out from the purified water tap, close the purified water tap. Then check whether the system has any leakage. If there is no leakage, connect a power supply. Activate an input mechanism “flushing” on the electronic control module 200 to manually activate the system flush feature. Now the screen would show a flushing code “2222.” When flushing is complete, the system enters a normal working status and the screen shows code a normal working status code “8888.” Open the purified water tap (not shown) until the filtered water is clean and no foam is observed. An additional feature of the electronic control module 200 is a “power off” protection feature, during which time, apparatus 100 will close all of the electrical valves and assure no water leaks out.

With reference to FIG. 5, the work flow of apparatus 100 is described in further detail. As a preliminary matter, apparatus 100 is connected to a centralized water supply line 540 (not shown) in a dwelling, or apparatus 100 is connected to a water supply source 541 (not shown), and the apparatus 100 is turned on. A user “activates” the functioning of the apparatus 100, when the user opens a tap 542 (not shown) or a faucet 544 (not shown) in a dwelling which has apparatus 100 connected to the centralized supply line 540, or a water supply source 541 (not shown). Activation is the initialization of the apparatus 100. When tap 542 or faucet 544 is opened, the pressure transmitter 524 detects a drop in pressure caused by the opening of the tap 542 or faucet 544, and sends a signal 546 (not shown) to the electric pump 520 to start pumping water through the apparatus 100. Upon receiving the signal 546, the electric pump 520 performs an electronic interrogation 580 (not shown) of the check valve 518 to confirm availability of feed water, at a pre-set rate 582 (not shown), which is pre-set by the user at an earlier time, and which is adequate for the UF membranes and other components in the apparatus 100 to function properly. Upon confirming availability of feed water at the pre-set rate 582, signals 548 (not shown) and 550 (not shown) are sent to open electric ball valves 512 and 514 respectively, while signals 552 (not shown) and 554 (not shown) are sent to close electricity ball valves 508 and 510 respectively. Water then flows from the feed water inlet 516 through the apparatus 100, gets filtered, and consequently, high quality water is delivered via the purified water outlet 526 to a water outlet 543 (not shown) or to the central supply line 540 where it flows to all taps, faucets or outlets, including the exemplary tap 542 and faucet 544.

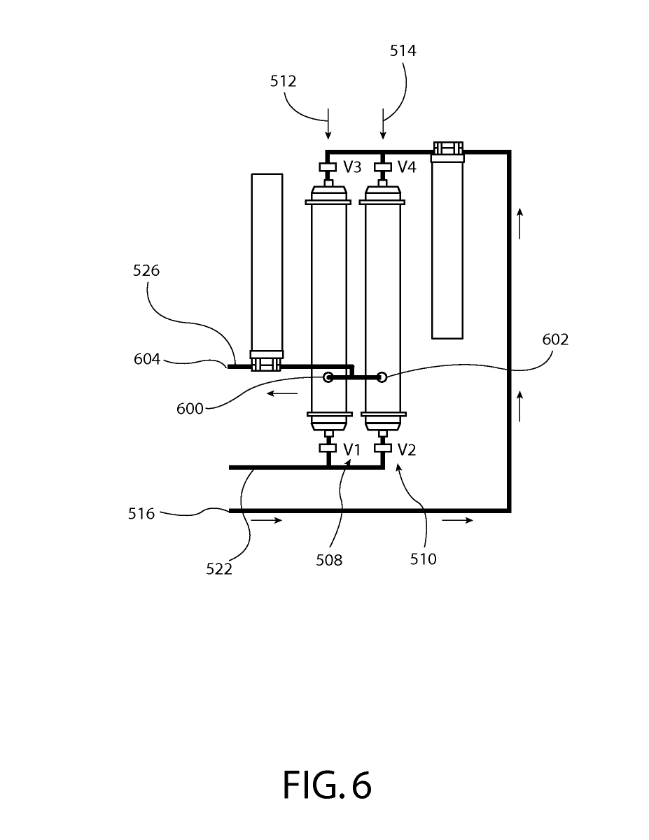

With reference to FIGS. 5 and 6, the filtration mechanism of apparatus 100 is described in further detail. Water initially flows from pump 520, to the first active carbon water filter 500, which removes, among other things, chlorine, sediment, volatile organic compounds (“VOCs”) and odor. Water then flows simultaneously through the first UF membrane 504, via the opening of the third electricity ball valve 512, and through the second UF membrane 506, via the opening of the fourth electricity ball valve 514. The first and second UF membranes 504 and 506 remove, among other things, contaminants such as mud/sand, rust, colloid, bacteria, viruses, suspensions and macromolecule organic matters, while keeping mineral substances, such as calcium, magnesium and potassium, which are beneficial to human body. The purified water filters from UF membranes 504 and 506, through openings 600 and 602 respectively, into a pipe 604, to the second active carbon filter 502. At the second active carbon filter 502, water taste is improved by the removal of, among other things, chlorine, sediment, VOCs and odor. Putting the water through two active carbon filters promotes an improved taste of the water. In one embodiment, the active carbon filters employed may be of the coconut shell active carbon filter variety. The purified water is then carried on purified water outlet 526 to the water outlet 543 (not shown), or to the central supply line 540 where it flows to all taps, faucets or outlets, including the exemplary tap 542 and faucet 544.

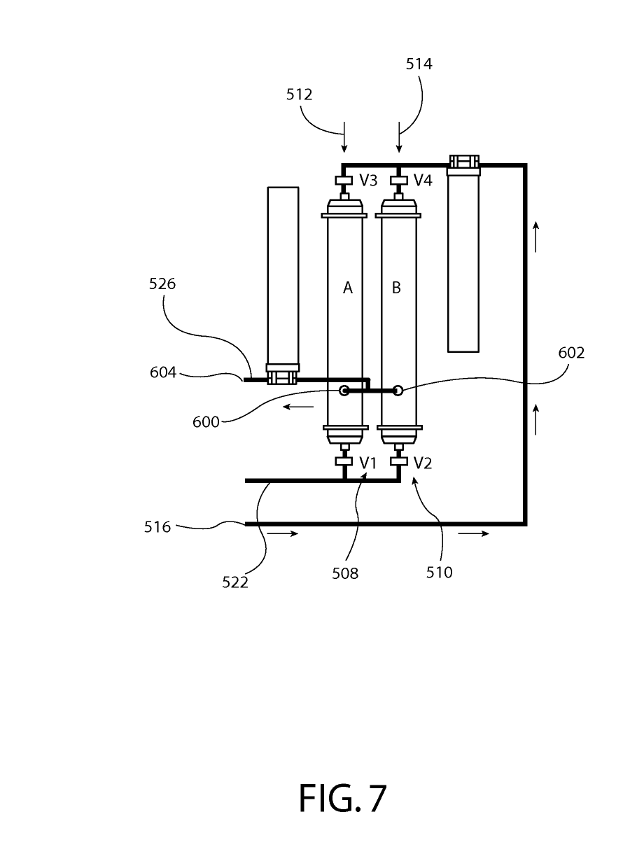

With reference to FIGS. 5, 6, and 7, the automatic flushing mechanism of apparatus 100 is described in further detail. After a certain amount of usage, UF membranes 504 and 506 may need to be cleaned in order to maintain the efficiency of the filters. Two different methods, a flush method, and a back flush method, are employed for said cleaning. A unique aspect of this invention is the ability of the apparatus 100 to “self-clean” the filters via programming a pre-set time (220 for flush, 222 for back flush of 504 and 224 for back flush of 506) in the programmable electronic control module 200.

Flush Method: At the pre-set time 220, the electronic control module 200 sends signals 240 (not shown) and 242 (not shown) to open electricity ball valves 508 and 510 respectively, and at the same time, sends signals 250 and 252 to keep electricity ball valves 512 and 514 open. Water goes through UF membranes 504 and 506, and ultimately flows to the drainage (not shown) through electricity ball valves 508 and 510 via drainage outlet 522, thereby flushing both UF membranes 504 and 506 simultaneously until clean.

Back Flush Method: If back flush is selected for UF membrane 504, at the pre-set time 222, the electronic control module 200 sends signals 260 (not shown) and 262 (not shown) to open electricity ball valves 508 and 514 respectively, and at the same time, sends signals 270 and 272 to keep electricity ball valves 510 and 512 closed. Water from the feed water inlet 516 is provided to the active carbon filter 500 where a first stage purified water is generated. This first stage purified water then goes through UF membrane 506 through the electricity ball valve 514, where it gets purified again to generate a second stage purified water. This second stage purified water is transported to the UF membrane 504 via openings 602 and 604 (shown in FIG. 6). Here, the second stage purified water is used to back flush the UF membrane 504, and the flushed water is drained to the drainage outlet 522 via the electricity ball valve 508. Closing electricity ball valve 510 prevents the second stage purified water from being drained out into the drainage water outlet 522. Similarly, if back flush is selected for UF membrane 506, at the pre-set time 224, the electronic control module 200 sends signals 280 (not shown) and 282 (not shown) to open electricity ball valves 510 and 512 respectively, and at the same time, sends signals 290 and 292 to keep electricity ball valves 508 and 514 closed. The back flush of the UF membrane 506 occurs in a similar fashion as described with reference to the back flush of the UF membrane 504. Water from the feed water inlet 516 is provided to the active carbon filter 500 where a first stage purified water is generated. This first stage purified water then goes through UF membrane 504 through the electricity ball valve 512, where it gets purified again to generate a second stage purified water. This second stage purified water is transported to the UF membrane 506 via openings 602 and 604 (shown in FIG. 6). Here, the second stage purified water is used to back flush the UF membrane 506, and the flushed water is drained to the drainage outlet 522 via the electricity ball valve 510. Closing electricity ball valve 508 prevents the second stage purified water from being drained out into the drainage water outlet 522. The UF membranes 504 and 506 are thereby cleaned via back flushing of water.

A tabular representation of the flushing and back flushing mechanisms is below.

TABLE 1

| Electrical valve | 508 | 510 | 512 | 514 |
|---|---|---|---|---|
| 504 back flushing | Open | Close | Close | Open |
| 506 back flushing | Close | Open | Open | Close |
| 504 and 506 flushing | Open | Open | Open | Open |

Users may utilize a set key (not shown) and adjust key (not shown) mechanisms to set and adjust the automatic flushing times on the electronic control module 200. As described earlier with reference to the system setup, Apparatus 100 may also be flushed manually by selecting a “flush” mechanism (not shown) on the electronic control module 200.

Apparatus 100 and the components of apparatus 100 are preferably installed on a frame, with an enclosure wrapping the frame. In one embodiment, apparatus 100 and the components of apparatus 100 utilize corrosion resistant stainless steel construction. For instance, any filters used in the apparatus 100, the frame of apparatus 100 and enclosure wrapping the frame of apparatus 100 may all be made from a variety of corrosion resistant stainless steel material. Employing corrosion resistant stainless steel material is especially helpful in tropical, sub-tropical, arid and semi-arid climatic conditions where apparatus 100 may be exposed to severe weather conditions which may lead to degeneration of apparatus 100 through corrosion and/or rust. In other embodiments, natural or man-made materials such as metals, metal derivatives, hydrocarbons, hydrocarbon derivatives, plastics, and fiberglass may be employed. In one embodiment, other improvements to apparatus 100, such as utilizing dust proof enclosures, may also be employed to protect apparatus 100 from severe weather conditions.

The above description of specific embodiments has been given by way of example. From the disclosure given, those skilled in the art will not only understand the general inventive concepts and attendant advantages, but will also find apparent various changes and modifications to the structures and methods disclosed. For example, the general inventive concepts are not typically limited to an apparatus configured to restrict water flow to 1000 liters per hour. Thus, for example, use of additional components of the apparatus 100 will result in higher flow rates. As a further example, the general inventive concepts are not typically limited to using apparatus 100 with just the filtration mechanisms provided. Apparatus 100 may also be configured to include additional filtration mechanisms such as a chlorination system, to aid in the transportation of purified water over distances. The specifications of the components are based on the requirements of water flow, and other technical parameters mentioned. The higher the flow rate desired, the bigger the components and vice versa. If the apparatus 100 reaches the limits of an assembly, apparatus 100 may be cascaded into multiple units, which may or may not be contained in one assembly. As another example, although the embodiments disclosed herein have been primarily directed to using apparatus 100 as a filtration device, the general inventive concepts could be readily extended to configure apparatus 100 to be used with any other apparatus which may perform other functions such as water cooling and/or water heating and/or water conditioning. It is sought, therefore, to cover all such changes and modifications as fall within the spirit and scope of the general inventive concepts, as described and claimed herein, and equivalents thereof.

### Second Embodiment

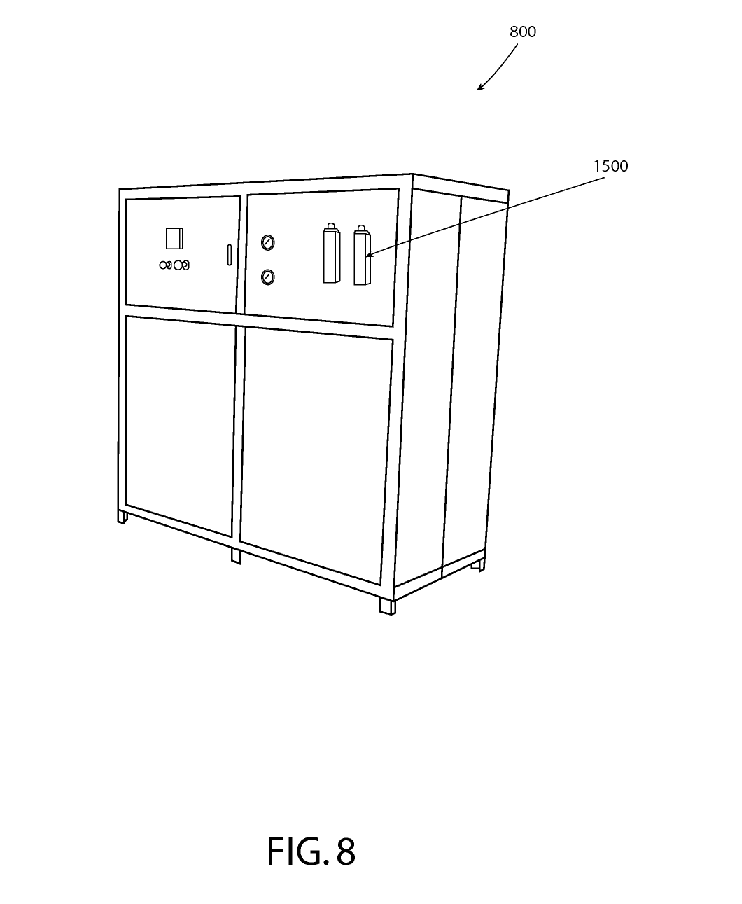

FIG. 8 depicts an exemplary apparatus 800 for centralized filtration of water.

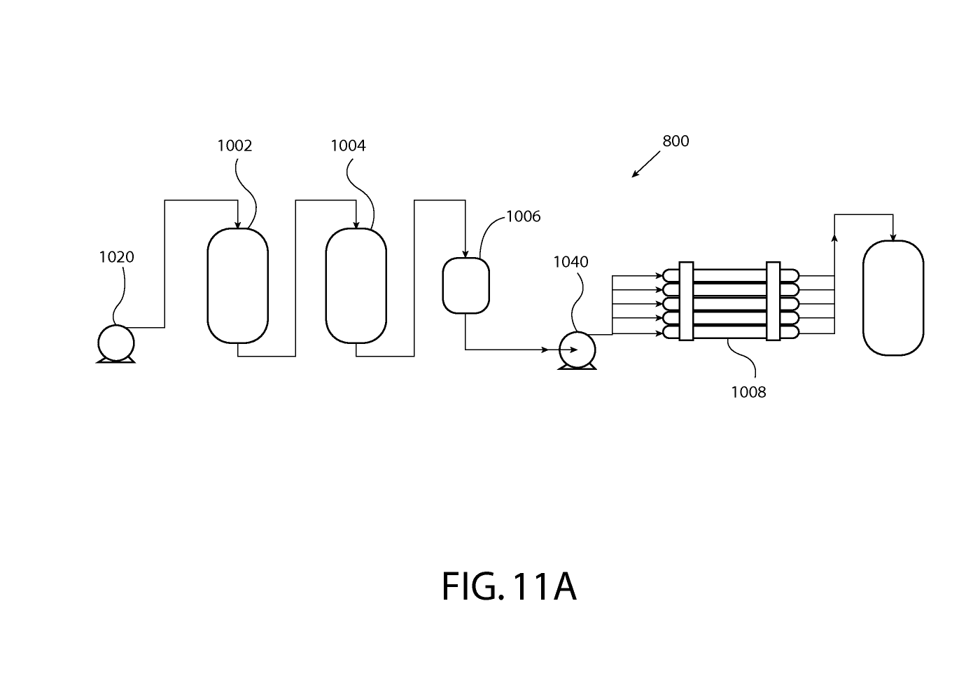

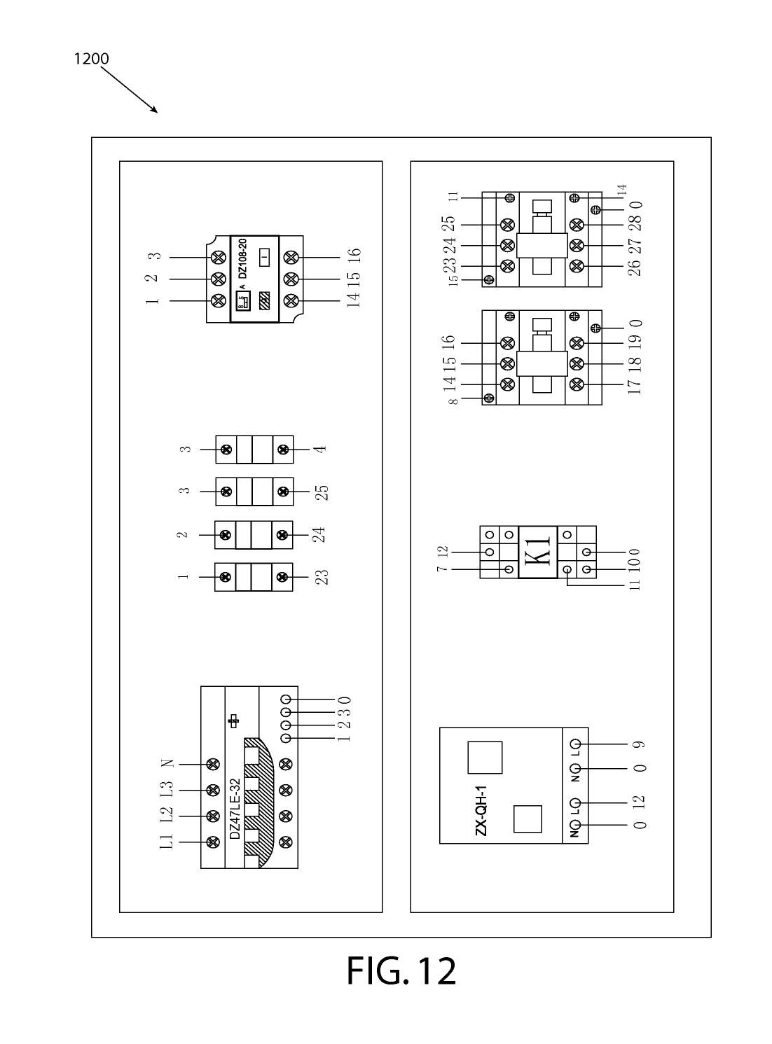

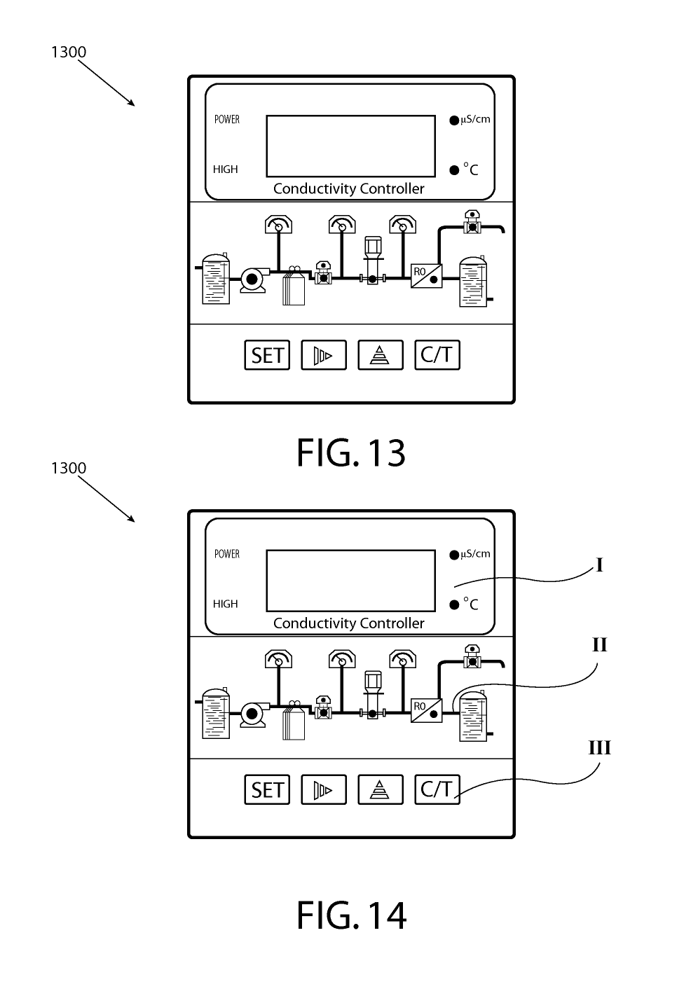

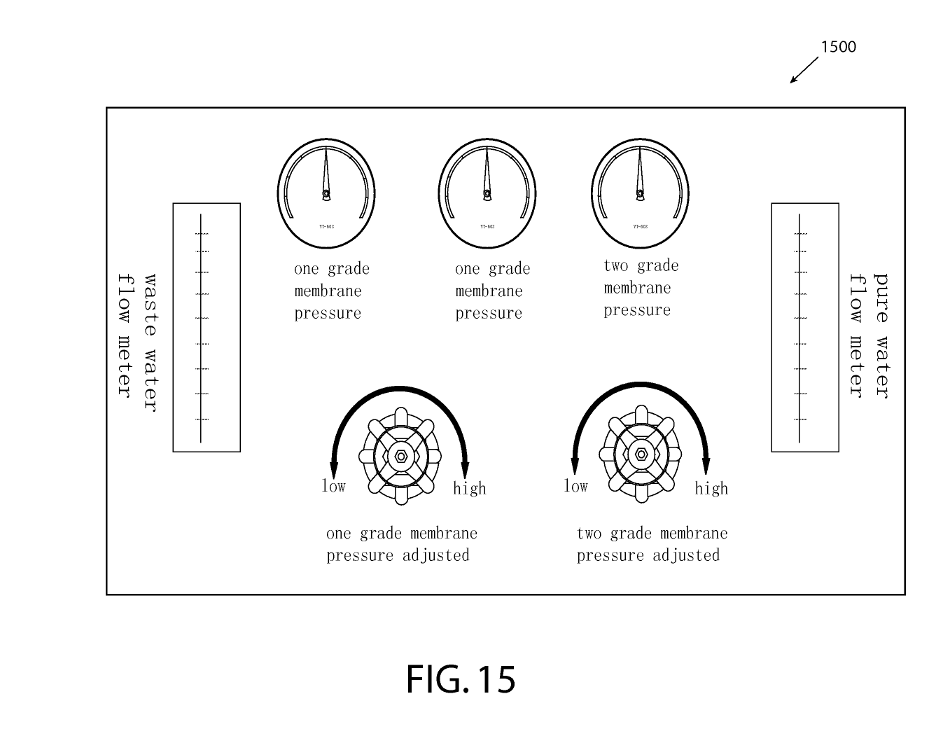

Apparatus 800 (FIG. 8) has a programmable electronic control module 1300 (FIGS. 13 and 14) with a microprocessor, through which the user may interact with the apparatus 800 and regulate various features and functioning of apparatus 800, such as a self cleaning operation of the apparatus 800. Apparatus 800 also comprises an instrument panel 1500 (FIGS. 1 and 15), which is utilized to communicate with apparatus 800 through the electronic control module 1300 and a controller 1200 (FIG. 12). The electronic control module 1300 provides the user the ability to input various parameters into apparatus 800, the instrument panel 1500 provides a way for the user to view information regarding the apparatus 800 (such as status messages), and the controller 1200 provides a way for the electronic control module 1300 to interact with the apparatus 800, serving as a conduit between the electronic control module's 1300 messages to the apparatus 800.

Apparatus 800 provides gauges (See FIG. 15) for measuring and displaying on the instrument panel 1500, the raw water pressure, raw water flow rate, pure water pressure and pure water flow rates. This provides the user the ability to see the flow of the water at the input and output stages of the filtration flow. This is done through having monitoring components in the flow which are connected to monitoring devices.

Various functions of the instrument panel 1500, in conjunction with programmable electronic control module 1300 and controller 1200, are described in detail below.

TABLE 2

| | |
|---|---|
| Anhydrous | (e.g. 1. tank low-water level, 2. water pressure too low “LOW |
| protection | FEED PRESS” indicator lights, buzzer rings and, controller |
| function | 1200 closes apparatus 800 automatically. When the water |
| | pressure or the water level returns to normal, the controller |
| | 1200 restarts the operation of the Reverse Osmosis system. |
| Low- | If the pre-treatment system in the flushing or regeneration or |
| voltage | security filter in the apparatus 800 cannot provide normal water |
| protection | pressure, lack of pressure, “LOW PRESS” indicator lights, |
| function | buzzer rings, and the controller 1200 will close apparatus |
| | 800 automatically. |
| | One minute later, apparatus 800 restarts, and if a low-pressure |
| | condition arises, the protection function once again shuts |
| | down the operation of apparatus 800. After three failed |
| | attempts to start apparatus 800 due to low pressure situation, |
| | the system enters a deadlock protection status, panel 1500 |
| | and low pressure indicator show as the diagnostic status. This |
| | can be manually reset through the rest button once pressure |
| | of the supply normalizes. |
| High- | Using a high-pressure protection system, when high pressure, |
| voltage | overpressure occurs, “HIGH PRESS” indicator lights, |
| protection | buzzer rings, the controller 1200 shuts down apparatus 800 |
| function | automatically until high pressure is eliminated. One minute |
| | later, the system restarts, and if the high pressure situation |
| | persists, the protection function again shuts down the |
| | operation of apparatus 800. After three failed attempts to start |
| | apparatus 800 due to a high pressure situation, the system |
| | enters a deadlock protection status. Panel 1500 and high |
| | voltage protection shown as the diagnostic status. This |
| | can be manually reset through the rest button once pressure |
| | of the supply normalizes. |
| Conduc- | When the conductivity value of the produced water is greater |
| tivity | than the set limit value, a “HIGH” indicator is ON, the buzzer |
| overrun | rings; the controller 1200 driver opens the bypass valve |
| alarm | excretion. When the conductivity of the water production is |
| | lower than the hysteresis limit value, the bypass valve closes, |
| | thereby ensuring that water flows to the outlet. |
| Membrane | Controller is pre-set to a desired time to start and stop |
| Flushing | membrane flushing operations, in accordance with the settings |
| Feature | in the electronic control module 1300. |

Instrument panel 1500 has several input or display mechanisms. An exemplary operational panel introduction to the instrument panel 1500 is provided below.

TABLE 2A

| item | introduction |
|---|---|
| start | manual start multi-phase |
| | pump (one grade) |
| stop | realize emergency stop |
| booster pump | start or stop booster pump |
| switch | |
| flushing switch | auto, manual flush optional |
| | switch |
| power supply | indicate power supply |
| indication | situation |
| water full | indicate water full situation |
| indication | |
| conductivity | indicate the conductivity |

In one embodiment, apparatus 800 is configured to operate as a centralized water filtration system for continuously flowing water supply. Apparatus 800 is configured to work even in tropical and sub-tropical climates, including arid and semi-arid conditions. Apparatus 800 functions by utilizing a sand filter, active carbon filter, a polypropylene sediment filter, and Reverse Osmosis (hereinafter referred to as “RO”) membranes that physically remove contaminants, including but not limited to, surface and sub-surface water contaminants with high concentrations (up to 8000 parts per million total dissolved solids (TDS)) of bacteria, viruses, other pathogens, as well as large organic molecules. Although the present apparatus 800 is described using RO membranes which can process up to 8000 parts per million TDS, different RO membranes with higher filtration capacity of TDS may be used. RO membranes are also configured to intake water with conductivity ≦400 Microsiemens per Centimeter, and remove materials such as sodium, potassium, magnesium, sand, grits, suspended substances, pesticide residue, heavy metallic ions, and carcinogenic substances such as chloroform and fluorine.

In one embodiment, apparatus 800 has a pure water output capacity of 250 liters per hour at 25° C. Exemplary parameters of apparatus 800 are presented in the table below.

TABLE 3
Capacity of pure [symbol] ,D 25° C.
General [symbol]
Electrical power : [symbol] [symbol]
(This can adapted to operating power supply specifications
anywhere in the world)
RO [symbol] LP-4040 [symbol]
Multi-phases [symbol] -180 [symbol] 1 item
Beforehand [symbol] [symbol]
PP sediment membranes [symbol] *500 [symbol] [symbol] [symbol]
Booster [symbol] 1 item
RO controller : [symbol]
Quartz sand [symbol]
Active carbon [symbol] [symbol]
frame with sealed
Out size of main

[symbol]

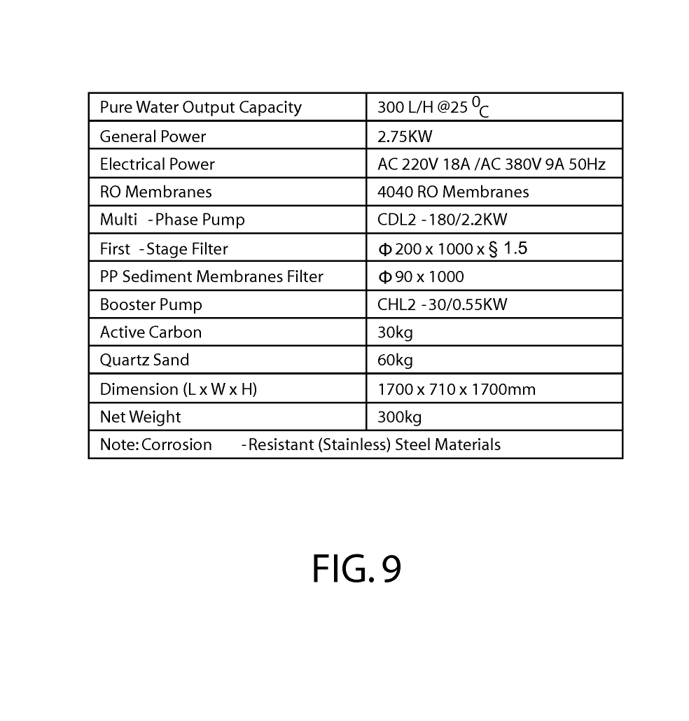

Water flow rates in apparatus 800 are adjustable. Moreover, apparatus 800 is also equipped with an outlet water pressure compensation function, which is designed to set the water flow pressure at different levels depending on the needs of the user, typically between 30 psi and 80 psi. For example, flow rates or water pressures required for high-capacity dwellings, such as apartments, offices, hotels, factories, hospitals, shopping malls, and restaurants are different from the flow rates or water pressures required at residential dwellings. One of ordinary skill in the art will appreciate that any other type of technical parameters may be utilized in the present invention, without deviating from the spirit and scope of the present invention. For example, an alternate power supply input of 277 Volts or any other voltage input may be used in the invention. Other technical parameters for an exemplary embodiment of apparatus 800 are described in FIG. 9.

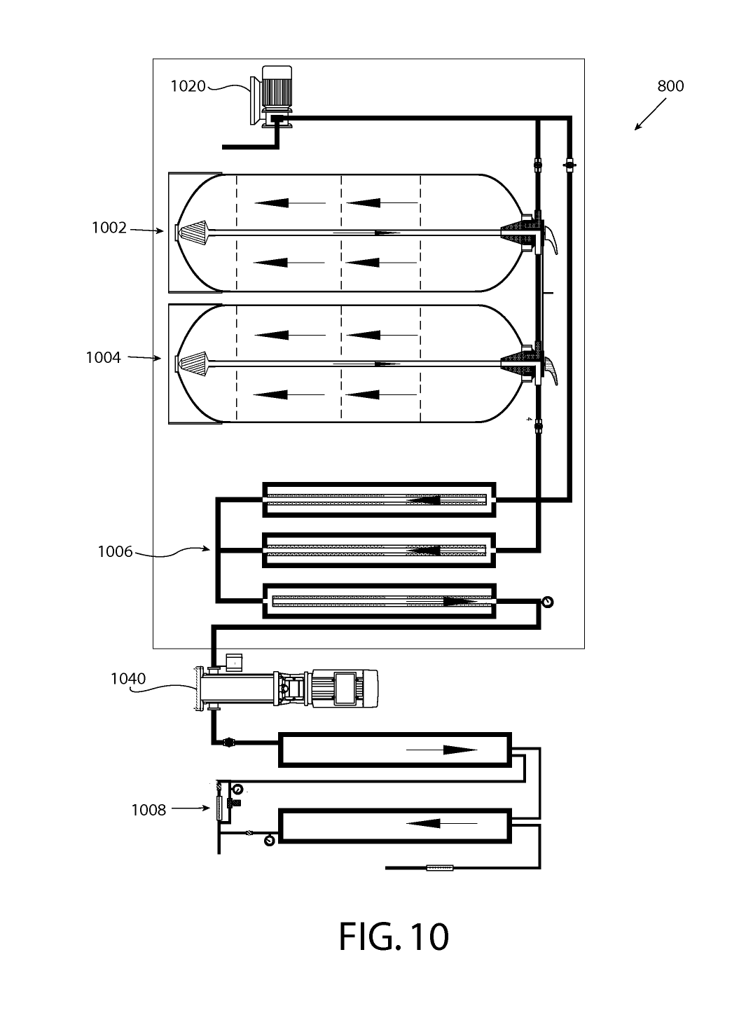

A schematic or structural drawing of the various components in apparatus 800 is shown in FIG. 10. Although the several components are shown as being attached or linked in a certain embodiment, one or ordinary skill in the art would appreciate that any combination of the several components may be incorporated without deviating from the spirit and scope of the present invention. Raw water moves from a water inlet source (not shown) to a raw water pump 1020. Water then moves to a Sand Filter 1002 (for example, a Quartz Sand Filter) via a valve 3. Here, big molecule impurities such as suspended substrates are removed. Water then moves to an Active Carbon Filter 1004 where organic substances, chlorine residue, smell, and color of the raw water are removed. Water then moves to a polypropylene (“pp”) Sediment Filter 1006 via valve 4 where suspended substances, rust, and small molecules are removed. Water then proceeds through a high pressure pump 1040 where water is pressurized in preparation for the reverse osmosis process. Water then moves through a regulating valve H (for regulating the water pressure) to a RO system 1008, which has more than one RO membranes, and preferably two membranes, a first stage membrane and a second stage membrane. Here, the water is rid of ions, organic substances, colloid and bacteria. Each of the RO membranes has a water outlet pipe which also has a pressure meter installed inline, to measure the pressure of the water outflow. The water outlet pipes are also used to filter out the waste water from the RO membranes. Therefore, water flows from the water inlet source through the apparatus 800, gets filtered, and consequently, high quality filtered water is delivered via a water outlet 843 (not shown). A flow meter is also installed inline with the water outlet 843 to measure the pressure of the purified water.

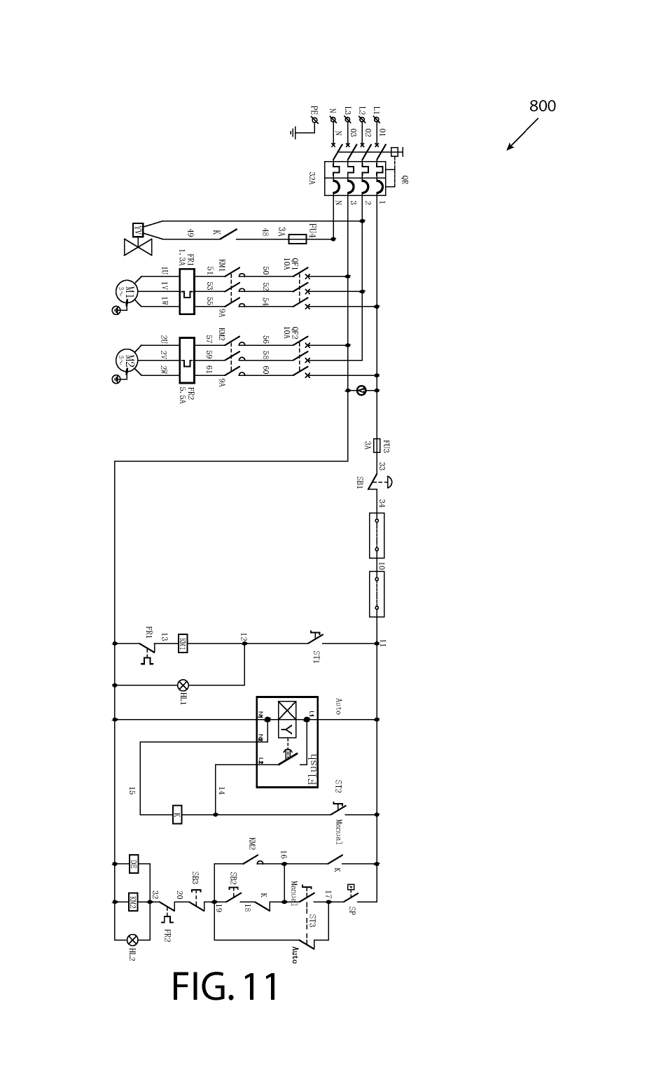

With reference to FIG. 11A, the workflow of apparatus 800 is described in further detail. In accordance with an embodiment of this invention, raw water moves from a water inlet source (not shown) to a raw water pump 1020. Water then moves to a Sand Filter 1002 (for example, a Quartz Sand Filter), then to an Active Carbon Filter 1004, then to a polypropylene (“pp”) Sediment Filter 1006, then through a high pressure pump 1040, and then to a RO system 1008, which has more than one RO membranes. Therefore, water flows from the water inlet source through the apparatus 800, gets filtered, and consequently, high quality filtered water is delivered via a water outlet 843 (not shown).

The various components of the apparatus 800 and their functioning are described in more detail below.

Quartz sand filter: In one embodiment, this filter 1002 is a 60 KG filter. Filter 1002 performs simple filtration of raw water, mainly leaching sediment and residue in raw water. For the purposes of filter 1002, when inlet pressure is 10 Psi (0.7 kg/cm2) higher than outlet pressure, or outlet water SDI (Silt Density Index)>5, a backwash is required. Frequent backwash of once a day is required for normal operation of the filter 1002. This is tedious if done manually; hence apparatus 800 includes the electronic control module 1300 to automate this functionality of initiating and completing back wash of the filter 1002.

Active carbon filter: In one embodiment, this filter 1004 is a 30 KG filter. Active carbon is a good adsorbent, is made of charcoal, various kinds of shell, and high quality coal through chemical or physical activation. It has many micro holes and a large specific surface area, which results in a very strong absorptive capacity that can absorb organic substances effectively, mainly to get rid of organic toxins, chlorine residue, smell, and color. Since chlorine residue decomposes the RO membranes, and shorten RO membranes' life, this filter is mainly used to absorb the chlorine residue, make the content of chlorine residue in raw water ≦0.1 mg/l, and protect the RO membrane from being damaged, thereby changing the active carbon according to the content of chlorine residue in the water. Frequent backwash of once a day is required for normal operation of filter 1004. This is tedious if done manually; hence apparatus 800 includes the electronic control module 1300 to automate this functionality of initiating and completing back wash of the filter 1004.

PP sediment filter: In The PP sediment filter 1006 is mainly used to get rid of small-molecule substances, making it fit for the next phase of the water treatment process, after the 1002 and 1004 filters. 1006 functions by getting rid of the suspended substances and rust. It can bear high pressure, and can be made from different materials to fit to different fluids. It has a small volume, a big filtering area, small resistance, and a long life. Placing it early on in a multi-phase system such as apparatus 800 helps to stop the active carbon particles, protect the RO membranes and the protect the multi-phase pumps from damage.

Reverse Osmosis apparatus: Reverse Osmosis system adopts a barrier separation method to wipe off ion, organic substances, colloidal particle, and bacteria, and desalinate raw water. Inlet water pressure, temperature, PH value and salinity can affect the RO membrane's function. Water under enough pressure goes through the RO membrane and becomes pure water, and what does not go through is the RO membrane ends up as waste water. The membranes used for reverse osmosis have a dense barrier layer (“barrier separation method”) where most of the water separation occurs. The membranes in the reverse osmosis apparatus are designed to allow only water to pass through the barrier layer while preventing the passage of solutes, such as salt ions. This process requires that a high pressure be exerted on the high concentration side of the membrane to overcome the natural osmotic pressure of the water.

Other optional apparatus: Additional components can be connected to apparatus 800 to meet user requirements. For example, if the requirement is to transport filtered water is over a long distance, a re-chlorination unit can be added to apparatus 800. A Re-mineralization unit that dissolves minerals back into the water can also be added if needed. In addition to these, the following sub-systems, available commercially can be installed with apparatus 800:
a. Water softener: Water softener is a device that wipes off calcium and magnesium-ions in water. Full-auto softener may also be used. Normally, a full-auto water softener's procedure includes: original water going through the softener (ion exchange resin inside) under rated pressure and flow. Sodium (Na++) in resin, exchanges with the cat ion (Ca++, Mg++, Fe++ etc) in water, making the content of Ca++, Mg++ in water reach a pre-set requirement. Adopt ion exchange theory comprises of three parts:
   Resin-function: exchange Ca++, Mg++ in original water, make water soft.
   Saline solution-function: exchange Ca++, Mg++ in resin, make resin regenerator.
   Control valve-function: controls the mode of operation.
b. Manganese ore: Manganese ore is mainly used to filter iron and manganese in groundwater. This product is made by natural manganese ore. The appearance is spherical, brown, and the product has a good capacity of wiping off iron and manganese. The manganese ore mainly exists in manganese dioxide form
c. Optional Equipment: Adding-medicine equipment is optional equipment. In order to ensure that the machine can work normally when water hardness is too high (hardness >100 mg/L), and in order to ensure the RO membrane does not get blocked quickly, user or manufacturer can add an RO scale inhibitor. In order to prevent colloid pollution, user or manufacturer can add flocculent before the quartz sand filter. If a user or manufacturer desires the water's PH value better, user or manufacturer can add a PH value reagent.

The producing water coefficient of RO membranes is discussed in the table below.

TABLE 4
Producing water coefficient of RO membranes

| Temperature [symbol] | 7 | 8 | 9 | 10 | 11 | 12 |
|---|---|---|---|---|---|---|
| Producing water | 1.783 | 1.723 | 1.666 | 1.611 | 1.558 | 1.508 |
| coefficient | | | | | | |
| Temperature [symbol] | 13 | 14 | 15 | 16 | 17 | 18 |
| Producing water | 1.458 | 1.412 | 1.367 | 1.323 | 1.282 | 1.242 |
| coefficient | | | | | | |
| Temperature [symbol] | 19 | 20 | 21 | 22 | 23 | 24 |
| Producing water | 1.203 | 1.166 | 1.13 | 1.096 | 1.062 | 1.030 |
| coefficient | | | | | | |
| Temperature [symbol] | 25 | 26 | 27 | 28 | 29 | 30 |
| Producing water | 1.000 | 0.970 | 0.942 | 0.914 | 0.887 | 0.861 |
| coefficient | | | | | | |
| Temperature [symbol] | 31 | 32 | 33 | 34 | 35 | 36 |
| Producing water | 0.836 | 0.812 | 0.789 | 0.767 | 0.745 | 0.724 |
| coefficient | | | | | | |

Apparatus 800 and the components of apparatus 800 are preferably installed on a frame, with an enclosure wrapping the frame. In one embodiment, apparatus 800 and the components of apparatus 800 utilize corrosion resistant stainless steel construction. For instance, any filters used in the apparatus 800, the frame of apparatus 800 and enclosure wrapping the frame of apparatus 800 may all be made from a variety of corrosion resistant stainless steel material. Employing corrosion resistant stainless steel material is especially helpful in tropical, sub-tropical, arid and semi-arid climatic conditions where apparatus 800 may be exposed to severe weather conditions which may lead to degeneration of apparatus 800 through corrosion and/or rust. In other exemplary embodiment, natural or man-made materials such as metals, metal derivatives, hydrocarbons, hydrocarbon derivatives, plastics, and fiberglass may be employed. In one embodiment, other improvements to apparatus 800, such as utilizing dust proof enclosures, may also be employed to protect apparatus 800 from severe weather conditions.

Exemplary photographs of an embodiment of apparatus 800 are disclosed in Appendix 1.

The above description of specific embodiments has been given by way of example. From the disclosure given, those skilled in the art will not only understand the general inventive concepts and attendant advantages, but will also find apparent various changes and modifications to the structures and methods disclosed. For example, the general inventive concepts are not typically limited to an apparatus configured to restrict water flow to 250 liters per hour. Thus, for example, use of additional components of the apparatus 800 will result in higher flow rates. As a further example, the general inventive concepts are not typically limited to using apparatus 800 with just the filtration mechanisms provided. Apparatus 800 may also be configured to include additional filtration mechanisms such as a chlorination system, to aid in the transportation of purified water over distances. The specifications of the components are based on the requirements of water flow, and other technical parameters mentioned. The higher the flow rate desired, the bigger the components and vice versa. If the apparatus 800 reaches the limits of an assembly, apparatus 800 may be cascaded into multiple units, which may or may not be contained in one assembly. As another example, although the embodiments disclosed herein have been primarily directed to using apparatus 800 as a filtration device, the general inventive concepts could be readily extended to configure apparatus 800 to be used with other any apparatus which may perform other functions such as water cooling and/or water heating and/or water conditioning. Further, some features of apparatuses 100 and 800 may been used interchangeably. For example, the flushing or back flushing mechanisms described with reference to apparatus 100 may be adopted to enable flushing or back flushing mechanisms in apparatus 800. It is sought, therefore, to cover all such changes and modifications as fall within the spirit and scope of the general inventive concepts, as described and claimed herein, and equivalents thereof

What is claimed:

1. A water filtration device comprising:
a water pump for providing water;
a first active carbon filter that receives water from the water pump;
a first ball valve having a first opening connected to the first active carbon filter;
a first ultrafiltration membrane that receives water from the first active carbon filter after it passes through the first opening;
a second ball valve having a second opening and connected downstream from the first ultrafiltration membrane;
a second ultrafiltration membrane that receives water from the first active carbon filter through the second opening, said second ultrafiltration membrane being positioned downstream said first active carbon filter, wherein water can flow simultaneously through the first ultrafiltration membrane and the second ultrafiltration membrane from the first active carbon filter;
a second active carbon filter connected downstream from the first and second ultrafiltration membranes that receives and filters water from the first and second ultrafiltration membranes; and
a purified water outlet connected to an outlet of the second active carbon filter.

2. The device of claim 1 further comprising a cover of corrosion resistant stainless steel material.

3. The device of claim 1 further comprising a dust-proof enclosure.

4. The device of claim 1 further comprising a first drainage outlet connected to the first ultrafiltration membrane.

5. The device of claim 1 further comprising a second drainage outlet connected to the second ultrafiltration membrane.

6. The device of claim 1 wherein the first and second active carbon filters are comprised of coconut shell active carbon.

7. A method of back flushing an ultrafiltration membrane comprising:
pumping raw water;
passing the pumped raw water through an active carbon filter to generate a first stage purified water;
passing the first stage purified water through a first ultrafiltration membrane to generate a second stage purified water; and
back flushing a second ultrafiltration membrane with the second stage purified water by passing the second stage purified water through the second ultrafiltration membrane.

8. A water filtration device comprising:
a water pump for providing raw water;
a first valve;
a sand filter that receives raw water from the water pump through the first valve;
an active carbon filter connected to the first valve downstream from said sand filter that receives water from the sand filter;
a second valve;
a sediment filter connected to the second valve downstream from said active carbon filter that receives water from the active carbon filter;
a second water pump that is connected downstream from the sediment filter and provides water received from the sediment filter downstream;
a regulating valve connected to an outlet of the second water pump;
a first stage reverse osmosis membrane connected downstream of the second water pump to the regulating valve that receives water from the second water pump;
a second stage reverse osmosis membrane connected downstream to the first stage reverse osmosis membrane that receives water from the first stage reverse osmosis membrane; and
a purified water outlet for purified water from the second stage reverse osmosis membrane.

9. The device of claim 8 having a cover made of corrosion resistant stainless steel material fully enclosing the device.

10. The device of claim 8 having a dust-proof enclosure.

11. The device of claim 8 wherein the active carbon filter is comprised of coconut shell.

12. The device of claim 8 wherein the active carbon filter removes chlorine residue from water.

13. The device of claim 8 wherein the sediment filter is comprised of polypropylene.

14. The device of claim 8 wherein the sediment filter removes active carbon particles.

15. The device of claim 8 wherein the first stage and second stage reverse osmosis membranes each comprises a dense barrier layer, wherein the dense barrier layer separates water from impurities.
